(19) United States
(12) Patent Application Publication
(10) Pub. No.: US 2010/0328357 A1
(43) Pub. Date: Dec. 30, 2010

(54) Drive Circuit, liquid crystal display device, and method for controlling output voltage

(76) Inventor: Takashi Yamauchi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/662,394

(22) Filed: Apr. 14, 2010

(30) Foreign Application Priority Data
Jun. 29, 2009 (JP) 2009-153372

(51) Int. Cl. G09G 5/10

(52) U.S. Cl. 345/690

(57) ABSTRACT

An exemplary embodiment of the present invention is a drive circuit for controlling an output voltage of display data supplied to a liquid crystal display panel includes a hold circuit that holds a gradient of the display data, a bit detection circuit that compares the gradient of the display data with a last gradient held in the hold circuit to thereby detect a comparison result, a current capability selection circuit that selects any of a plurality of current capabilities in synchronization with a bit comparison signal based on the detected comparison result, and an output circuit that converts the display data into a voltage according to the gradient thereof using the selected current capability and outputs the converted voltage.

### INCORPORATION BY REFERENCE

This application is based upon and claims the benefit of priority from Japanese patent application No. 2009-153372, filed on Jun. 29, 2009, the disclosure of which is incorporated herein in its entirety by reference.

### BACKGROUND

1. Field of the Invention

The present invention relates to a drive circuit, a liquid crystal display device, and a method for controlling output voltage, and particularly to a drive circuit that controls an output voltage of display data supplied to a liquid crystal display panel, a liquid crystal display device, and a method for controlling output voltage.

2. Description of Related Art

Liquid crystal display devices have been equipped in many recent portable products represented by mobile telephones, and power supply to the liquid crystal display devices is performed using batteries. In the equipped liquid crystal display devices, gradient etc. have been improved to sharply display a lot of information, but on the other side of it, consumption current increases and the batteries are consumed heavily. For this reason, a liquid crystal display device is desired that can operate for a long time and that has low power consumption. It is to be noted that the gradient indicates a rate of change of pixel intensity in image processing or in the display device.

For example, Japanese Unexamined Patent Application Publication No. 2003-216118 discloses a technique that power consumption of a whole liquid crystal display device is reduced by setting a current from an output circuit of a source driver to a liquid crystal display panel to a most suitable value according to a gradient of display data. FIG. 7 is a block diagram showing a configuration of a main part of a drive circuit mounted in a liquid crystal display device of a prior art disclosed in Japanese Unexamined Patent Application Publication No. 2003-216118.

As shown in FIG. 7, the drive circuit of the prior art is provided with a bit detection circuit 150 that detects a bit of display data input into the source driver, a current capability selection circuit 200 that controls a most suitable current capability for the input display data, an output circuit 300 that transmits the display data to a liquid crystal display device, etc. The current capability selection circuit 200 has a constant current source 210a used at a display pattern with much black color, a constant current source 210b used at a display pattern with much half-tone color, a constant current source 210c used at a display pattern with much white color, and changeover switches 220a, 220b, and 220c connected thereto, respectively.

The display data input into the source driver, which is a drive circuit, is sent to a D/A converter via a display data processing circuit based on the control by a control signal from a signal processing circuit that controls the whole liquid crystal display device. The D/A converter converts a digital signal processed in the display data processing circuit into an analog one, and then transmits the display data to the output circuit 300.

In addition, the display data is imported into the display data processing circuit, and at the same time, it is imported into the bit detection circuit 150. In this bit detection circuit 150, the display data is separated into a plurality of cases according to a bit comparison signal from the signal processing circuit. For example, if both of most significant two bits of the display data are “1”, the bit comparison signal determines the data as white color, if both “0”, black color, and in the other cases, half-tone color, whereby the display data is separated into three cases.

For example, if a gradient of six bits of display data input into the source driver is “101010”, the gradient of the display data is determined as data with much half-tone color in the bit detection circuit 150. The changeover switch 220b in the current capability selection circuit 200 is then connected, whereby the constant current source 210b most suitable for displaying half-tone color is selected, and the data is sent from the output circuit 300 to a liquid crystal display panel.

In addition, for example, if the gradient of the six bits of display data input into the source driver is “000000”, the gradient of the display data is determined as data with much black color in the bit detection circuit 150. The changeover switch 220a in the current capability selection circuit 200 is then connected, whereby the constant current source 210a with the highest capability is selected to display data with much black color, and the data is sent from the output circuit 300 to the liquid crystal display panel.

Further, for example, if the gradient of the six bits of display data input into the source driver is “111111”, the gradient of the display data is determined as data with much white color in the bit detection circuit 150. The changeover switch 220c in the current capability selection circuit 200 is then connected, whereby the constant current source 210c with the lowest capability is selected to display data with much white color, and the data is sent from the output circuit 300 to the liquid crystal display panel.

FIG. 8 shows respective maximum allowable current capabilities of the constant current sources 210a, 210b, and 210c in the drive circuit of the prior art shown in FIG. 7. As shown in FIG. 8, the constant current source 210a with the highest capability is used with respect to the display data with much black color, whereby a voltage denoted as an output potential V_{A} can be supplied at a time t₀. On the contrary, the constant current source 210c with the lowest capability is used with respect to the display data with much white color, whereby a voltage denoted as an output potential V_{C} can be supplied at the time t₀. In addition, the constant current source 210b with middle capability is used with respect to the display data with much half-tone color, whereby a voltage denoted as an output potential V_{B} can be supplied at the time t₀. Namely, it becomes possible to supply a current according to a bit of input display data to the liquid crystal display panel.

As described above, the drive circuit of the prior art shown in FIG. 7 selects any of the constant current sources 210a, 210b, and 210c in the current capability selection circuit 200 based on a gradient of display data, and supplies a voltage according to a bit of the display data to the liquid crystal display panel, whereby unnecessary consumption current is reduced in the whole liquid crystal display device. Each time display data is repeatedly input, a voltage is repeatedly supplied to the liquid crystal display panel according to a gradient of the display data.

However, in the drive circuit of the prior art, when the voltage is repeatedly supplied according to the gradient, the voltage is shifted to a voltage according to a gradient of the next display data after once experiencing a potential V₀ lower than the output potential V_{C} as an initial value. This is because a voltage supplied to the liquid crystal display panel is a voltage according to a bit of the display data, and the initial value of a timing chart shown in FIG. 8 is the arbitrary voltage (V₀) lower than the output potential V_{C}. Namely, an output voltage, which is supplied to the liquid crystal display panel from the constant current source selected according to the bit of the display data, starts from the arbitrary potential V₀ lower than the output potential V_{C} each time the display data is repeatedly input, and then it rises to each output potential according to the display data.

Here, in a liquid crystal display device having the drive circuit of the prior art mounted therein, specific operations when the display data is repeatedly input will be explained using FIGS. 9A to 9C. FIGS. 9A to 9C are timing charts showing shifts of output potentials in the liquid crystal display device having the drive circuit of the prior art mounted therein. Hereinafter, for example, the following two data will be explained as an example of repeatedly input display data: currently displayed data (hereinafter referred to as current display data); and data input after the current display data is output and displayed following the current display data (hereinafter referred to as next display data). In addition, assume that a time at which a gradient of the current display data is output is t₀, and a time at which a gradient of the next display data is output is t₁ in FIGS. 9A to 9C.

FIG. 9A is a timing chart showing a shift from the output potential V_{A} of the current display data to the output potential V_{A} of the next display data, the shift being without a potential change. As shown in FIG. 9A, after outputting the output potential V_{A} of the current display data at the time t₀, the V₀ is once experienced before shifting from the output state to the output potential V_{A} of the next display data at the time t₁. For that reason, a time period tp is required for shifting from the V_{A} potential to the V₀.

FIG. 9B is a timing chart showing a shift from the output potential V_{A} at the time t₀ to the output potential V_{B} at the time t₁, the shift being with a potential change. As shown in FIG. 9B, after outputting the output potential V_{A} of the current display data at the time t₀, the V₀ is once experienced before shifting from the output state to the output potential V_{B} of the next display data at the time t₁. For that reason, similarly in this case, the time period tp is required for shifting from the V_{A} potential to the V₀.

In addition, FIG. 9C is a timing chart showing a shift from the output potential V_{A} at the time t₀ to the output potential V_{C} at the time t₁, the shift being with a largest potential change. As shown in FIG. 9C, after outputting the output potential V_{A} of the current display data at the time t₀, the V₀ is once experienced before shifting from the output state to the output potential V_{C} of the next display data at the time t₁. For that reason, similarly in this case, the time period tp is required for shifting from the V_{A} potential to the V₀.

We have now discovered that as described above, in the drive circuit of the prior art, as for the operations that the display data is repeatedly input, the output potential is always set to the V₀ once from the one according to the gradient of the current display data, and then raised to the one according to the gradient of the next display data. Namely, the time period tp is required for once shifting from the current output potential to the V₀ when shifting to the output potential of the next display data. For that reason, there is a problem in the drive circuit of the prior art that a current corresponding to a value obtained by multiplying the number of times the display data is repeatedly input by the time period tp is wasted.

### SUMMARY

A first exemplary aspect of an embodiment of the present invention is a drive circuit for controlling an output voltage of display data supplied to a liquid crystal display panel. The drive circuit includes a hold circuit that holds a gradient of the display data, a bit detection circuit that compares the gradient of the display data with a last gradient held in the hold circuit to thereby detect a comparison result, a current capability selection circuit that selects any of a plurality of current capabilities in synchronization with a bit comparison signal based on the detected comparison result, and an output circuit that converts the display data into a voltage according to the gradient thereof using the selected current capability and outputs the converted voltage. According to the first exemplary aspect of an embodiment of the present invention, an output potential according to a gradient of a display data can be directly shifted from an output potential according to the last gradient of the display data without passing through the V₀. Hence, wasting power due to once passing through the V₀ can be prevented.

A second exemplary aspect of an embodiment of the present invention is a method for controlling an output voltage of display data supplied to a liquid crystal display panel. The method includes holding a gradient of a first display data, detecting a comparison result by comparing a gradient of a second display data input following the first display data with the gradient of the held first display data, selecting any of a plurality of current capabilities in synchronization with a bit comparison signal based on the comparison result, and converting the second display data into a voltage according to the gradient thereof using the selected current capability to output the converted voltage. According to the second exemplary aspect of an embodiment of the present invention, an output potential according to the gradient of the second display data can be directly shifted from an output potential according to the gradient of the first display data without passing through the V₀. Hence, wasting power due to once passing through the V₀ can be prevented.

According to the present invention, it is possible to provide a drive circuit, a liquid crystal display device, and a method for controlling an output voltage capable of reducing power consumption.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing one example of a configuration of a drive circuit according to an embodiment of the present invention;

FIG. 2 is a block diagram showing one example of detailed configurations of a hold circuit and a bit detection circuit of the drive circuit according to the embodiment of the present invention;

FIG. 3 is a timing chart showing an operation in a case where a display data is repeatedly input into the drive circuit according to the embodiment of the present invention;

FIG. 4 is a timing chart showing an operation in a case where the display data is repeatedly input into the drive circuit according to the embodiment of the present invention;

FIG. 5 is a timing chart showing an operation in a case where the display data is repeatedly input into the drive circuit according to the embodiment of the present invention;

FIGS. 6A to 6C are timing charts showing shifts of output potentials in a liquid crystal display device that mounts the drive circuit of the embodiment of the present invention;

FIG. 7 is a block diagram showing a configuration of a main part of a drive circuit mounted in a liquid crystal display device according to prior art;

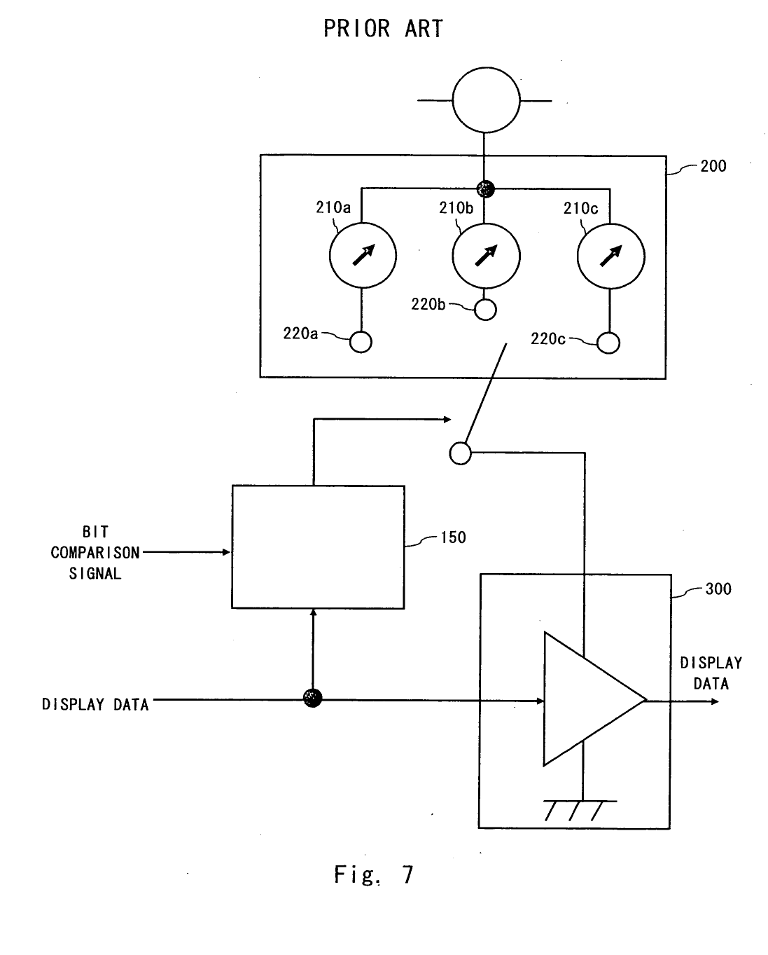

FIG. 8 shows respective maximum allowable current capabilities of the constant current sources in the drive circuit according to prior art; and

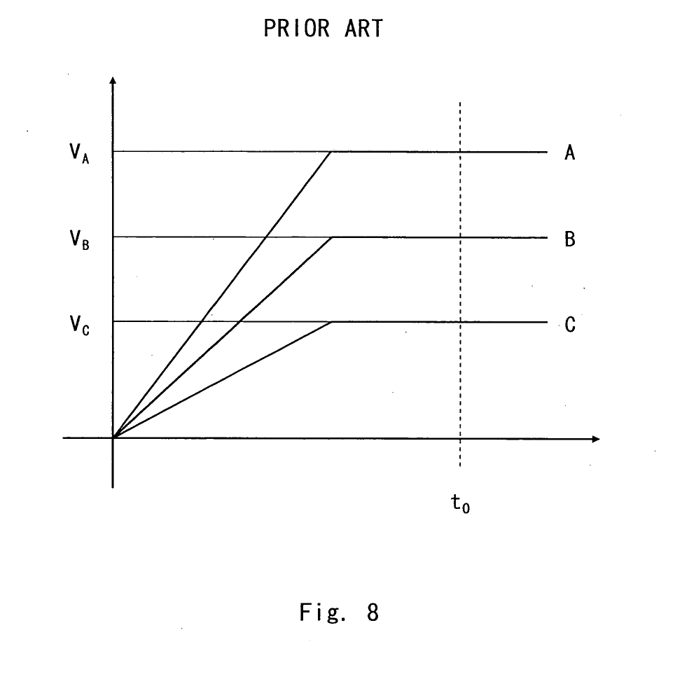

FIGS. 9A to 9C are timing charts showing shifts of output potentials in the liquid crystal display device having the drive circuit mounted therein according to prior art.

### DETAILED DESCRIPTION OF THE EXEMPLARY EMBODIMENTS

Hereafter, an embodiment of the present invention will be explained with reference to drawings. For clarity of explanation, description and the drawings below are arbitrarily omitted and simplified. In addition, for clarity of explanation, duplicated explanations are omitted as necessary. Note that the same reference numerals denote the same components in each drawing, and explanations thereof are arbitrarily omitted.

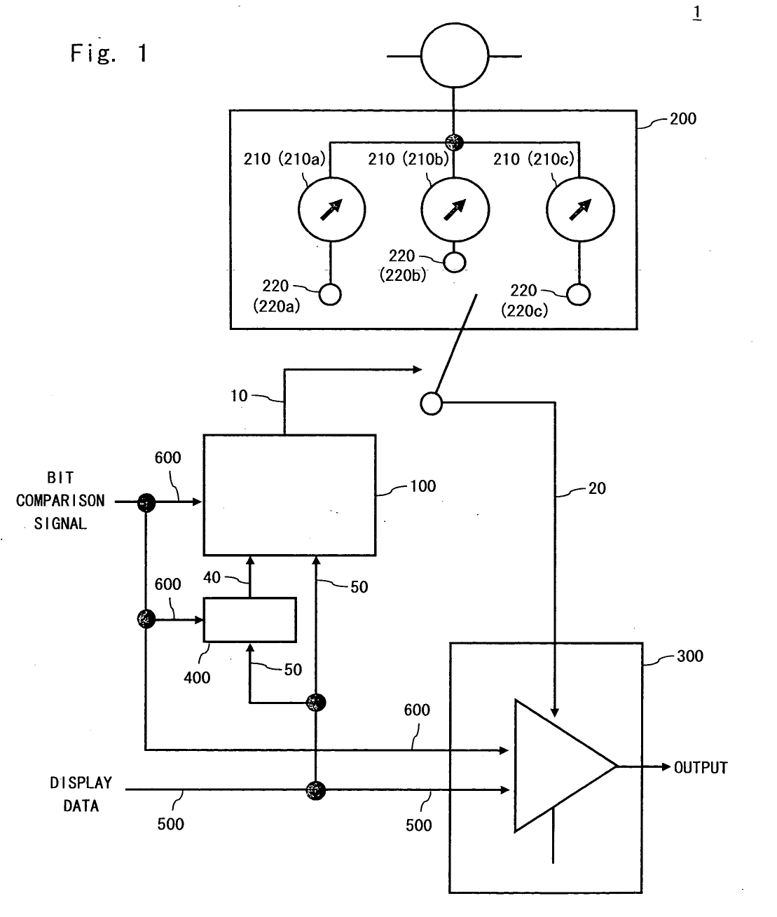

First, a configuration of a drive circuit mounted in a liquid crystal display device according to an embodiment of the present invention will be explained using FIG. 1. FIG. 1 is a block diagram showing one example of the configuration of the drive circuit according to the present embodiment. The drive circuit according to the embodiment of the present invention is a drive circuit that controls an output voltage of display data supplied to a liquid crystal display panel, and that is mounted in the liquid crystal display device in order to efficiently output a suitable output power to the liquid crystal display panel. This drive circuit is mounted in the liquid crystal display device as, for example, a part of a source driver.

As shown in FIG. 1, a drive circuit 1 according to the embodiment of the present invention is provided with an output circuit 300, a current capability selection circuit 200, a bit detection circuit 100, and a hold circuit 400. Display data 500 is supplied to the hold circuit 400, the bit detection circuit 100, and the output circuit 300. This display data 500 is composed of a plurality of bits. Hereinafter, a case will be explained as an example where six bits of display data 500 is supplied.

The hold circuit 400 holds (stores) gradients of the display data 500. Specifically, for example, most significant two bits of display data 50 of the supplied six bits of display data 500 are input into the hold circuit 400, and the hold circuit 400 holds the input most two bits of display data 50. Subsequently, the hold circuit 400 outputs the held most significant two bits of display data 50 as held data 40 in synchronization with a bit comparison signal 600. As described above, the hold circuit 400 holds at least one or more bits of the plurality of bits that constitute the display data 500 as gradients of the display data 500.

The bit detection circuit 100 performs data comparison for setting a suitable output power based on comparing with a last gradient. Namely, the bit detection circuit 100 compares a gradient of the display data 500 with the last gradient held in the hold circuit 400, and then detects a comparison result. Specifically, into the bit detection circuit 100 input are the held data 40 output from the hold circuit 400 and the same most significant two bits of display data 50 as inputs to the hold circuit 400. The bit detection circuit 100 compares the input held data 40 with the input display data 50, and then holds a comparison result. Subsequently, the bit detection circuit 100 outputs the held comparison result as a current capability selection signal 10 in synchronization with the bit comparison signal 600.

The current capability selection circuit 200 selects any of the plurality of current capabilities in synchronization with the bit comparison signal 600 based on the comparison result detected by the bit detection circuit 100. Specifically, the current capability selection circuit 200 has a plurality of constant current sources 210 with different current capabilities, and changeover switches 220 connected to the plurality of constant current sources 210, respectively. Here, the current capability selection circuit 200 has three constant current sources 210a, 210b, and 210c, and three changeover switches 220a, 220b, and 220c connected thereto, respectively. For example, assume that the constant current source 210a has a highest current capability, and the constant current source 210c has a lowest one. In addition, assume that the constant current source 210b has a middle current capability, which is, i.e., a current capability between the capabilities of the constant current source 210a and the constant current source 210c. Consequently, a relation of the above-described current capabilities can be expressed as: the constant current source 210a>the constant current source 210b>the constant current source 210c.

The current capability selection signal 10 output from the bit detection circuit 100 is input into the current capability selection circuit 200, which selects any of the constant current sources 210 based on this current capability selection signal 10. Specifically, in the current capability selection circuit 200, any of the changeover switches 220a, 220b, and 220c is connected based on the input current capability selection signal 10, whereby any of the constant current sources 210a, 210b, and 210c is selected. In addition, the current capability selection circuit 200 outputs a constant current signal 20 from the selected constant current source 210.

The output circuit 300 converts the display data 500 into a voltage according to a gradient thereof using the current capability selected by the current capability selection circuit 200, and then outputs it. Specifically, into the output circuit 300 input are the constant current signal 20 output from the current capability selection circuit 200, and the supplied display data 500. Subsequently, the output circuit 300 converts the display data 500 into the voltage according to the gradient thereof using the constant current signal 20 in synchronization with the bit comparison signal 600, and then outputs it. For example, if both of most significant two bits of the display data are “1”, the data is determined as white color, and the display data 500 is converted into a voltage V_{A} to be output. In addition, if both of the most significant two bits of the display data are “0”, the data is determined as black color, and then the display data 500 is converted into a voltage V_{C} to be output. Further, in the other cases, the display data is determined as half-tone color, and then the display data 500 is converted into a voltage V_{B} to be output.

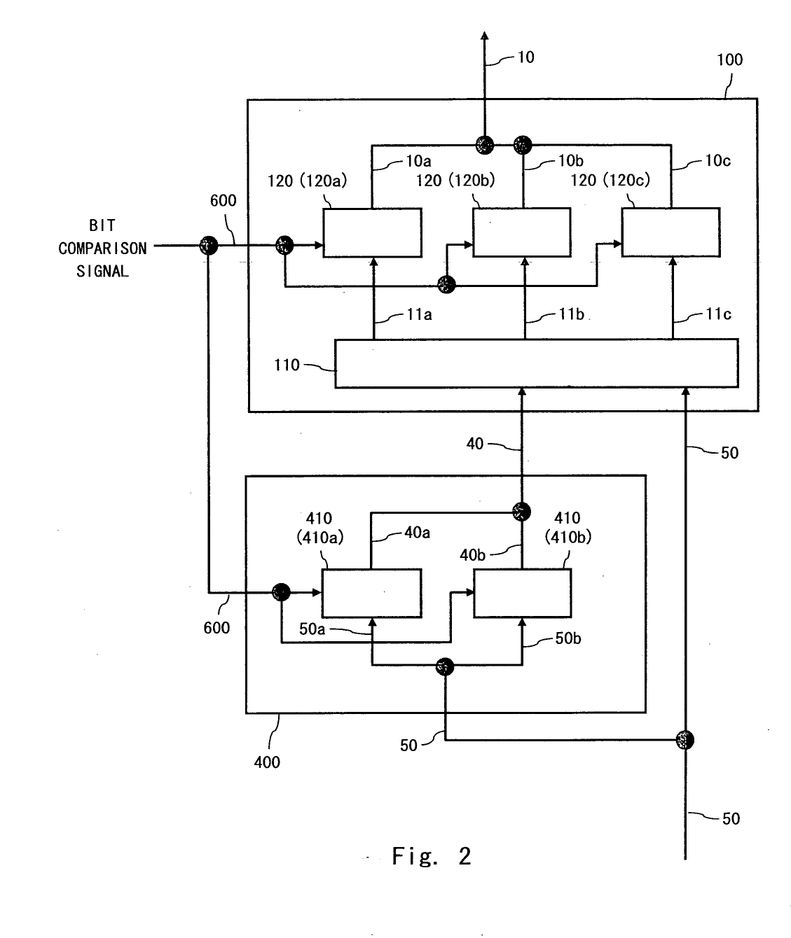

Here, detailed configurations of the hold circuit 400 and the bit detection circuit 100 will be explained using FIG. 2. FIG. 2 is a block diagram showing one example of the detailed configurations of the hold circuit 400 and the bit detection circuit 100 of the drive circuit 1 according to the embodiment of the present invention.

In FIG. 2, the hold circuit 400 has at least one or more first registers 410 for holding (storing) the gradient of the display data 500 by the bit. Here, two first registers 410 are provided as an MSB1 register 410a and an MSB2 register 410b in order to hold the most significant two bits of the display data 50 of the display data 500 composed of six bits.

The MSB1 register 410a holds display data 50a that is one of the most significant two bits of the display data 50 input into the hold circuit 400. For example, assume that the most significant bit is the display data 50a. Subsequently, the MSB1 register 410a outputs the held display data 50a as held data 40a in synchronization with the bit comparison signal 600.

Similarly, the MSB2 register 410b holds display data 50b that is the other one of the most significant two bits of the display data 50 input into the hold circuit 400. For example, assume that the second most significant bit is the display data 50b. Subsequently, the MSB2 register 410b outputs the held display data 50b as held data 40b in synchronization with the bit comparison signal 600.

In this manner, the held data 40a and 40b held by the bit and output from the first register 410 are gathered as held data 40, and are output from the hold circuit 400. Namely, here, the most significant two bits of the gradient of the display data 500 are held as the held data 40.

Meanwhile, the bit detection circuit 100 has a data comparison circuit 110 that compares the gradient of the display data 500 with the last gradient and detects comparison results, and a plurality of second registers 120 for holding the comparison results corresponding to the plurality of constant current sources 210, respectively. Here, three second registers 120a, 120b, and 120c are provided so as to correspond to the three constant current sources 210a, 210b, and 210c.

The data comparison circuit 110 compares the gradients using at least one or more bits of the plurality of bits that constitute the display data 500. Subsequently, the data comparison circuit 110 groups comparison results obtained by this comparison into at least two or more cases. If both the gradient of the display data 500 and the last gradient are white or black color, the data comparison circuit 110 detects a comparison result for selecting the lowest current capability of the plurality of current capabilities. In addition, if either of the gradient of the display data 500 or the last gradient is white color, and if the other one is black, the data comparison circuit 110 detects a comparison result for selecting the highest current capability of the plurality of current capabilities. Here, for example, he data comparison circuit 110 compares the gradients using the most significant two bits, and then groups the comparison results into three cases.

The held data 40 and the display data 50 input into the bit detection circuit 100 are also input into the data comparison circuit 110. The data comparison circuit 110 compares the display data 50 with the held data 40, and outputs the comparison results to each of the second registers 120. Namely, the data comparison circuit 110 groups the comparison results into several cases based on comparing with the last gradient, and then outputs any of a plurality of comparison result signals 11a, 11b, and 11c to the corresponding second register 120.

Here, for example, assume that if both of the most significant two bits of the gradient are “1”, the display data is determined as white color, if both “0”, black, and in the other cases, half-tone, and then the gradients are compared. If the gradient of the display data 50 to be compared is then white or black color, and if the last gradient is the same white or black color as that, the comparison result signal 11c is output for selecting the constant current source 210c with the lowest current capability. On the contrary to this, if the gradient of the display data 50 to be compared is white or black color, and if the last gradient is black or white color different from that, the comparison result signal 11a is output for selecting the constant current source 210a with the highest current capability. Meanwhile, in cases other than the above-described combination, the comparison result signal 11b is output for selecting the constant current source 210b with the middle current capability.

The second registers 120 hold (store) the comparison result signals 11a, 11b, and 11c input from the data comparison circuit 110, and then output them in synchronization with the bit comparison signal 600. Specifically, when the comparison result signal 11a is input into the second register 120a corresponding to the constant current source 210a, the second register 120a holds this comparison result signal 11a. Subsequently, the second register 120a outputs the held comparison result signal 11a as a current capability selection signal 10a in synchronization with the bit comparison signal 600.

Similarly, when the comparison result signal 11b is input into the second register 120b corresponding to the constant current source 210b, the second register 120b holds this comparison result signal 11b. Subsequently, the second register 120b outputs the held comparison result signal 11b as a current capability selection signal 10b in synchronization with the bit comparison signal 600. In addition, when the comparison result signal 11c is input into the second register 120c corresponding to the constant current source 210c, the second register 120c holds this comparison result signal 11c. Subsequently, the second register 120c outputs the held comparison result signal 11c as a current capability selection signal 10c in synchronization with the bit comparison signal 600.

In this manner, the plurality of current capability selection signals 10a, 10b, and 10c output from the plurality of second registers 120, respectively are gathered as the current capability selection signal 10 to be output from the bit detection circuit 100. It is to be noted that the held data 40 to be compared with the display data 50 in the data comparison circuit 110 is the gradient of the display data 50 having supplied to the drive circuit 1 just before the display data 50. Consequently, the bit detection circuit 100 outputs the current capability selection signal 10 for selecting any of the constant current sources 210 of the current capability selection circuit 200 based on comparing with the last gradient.

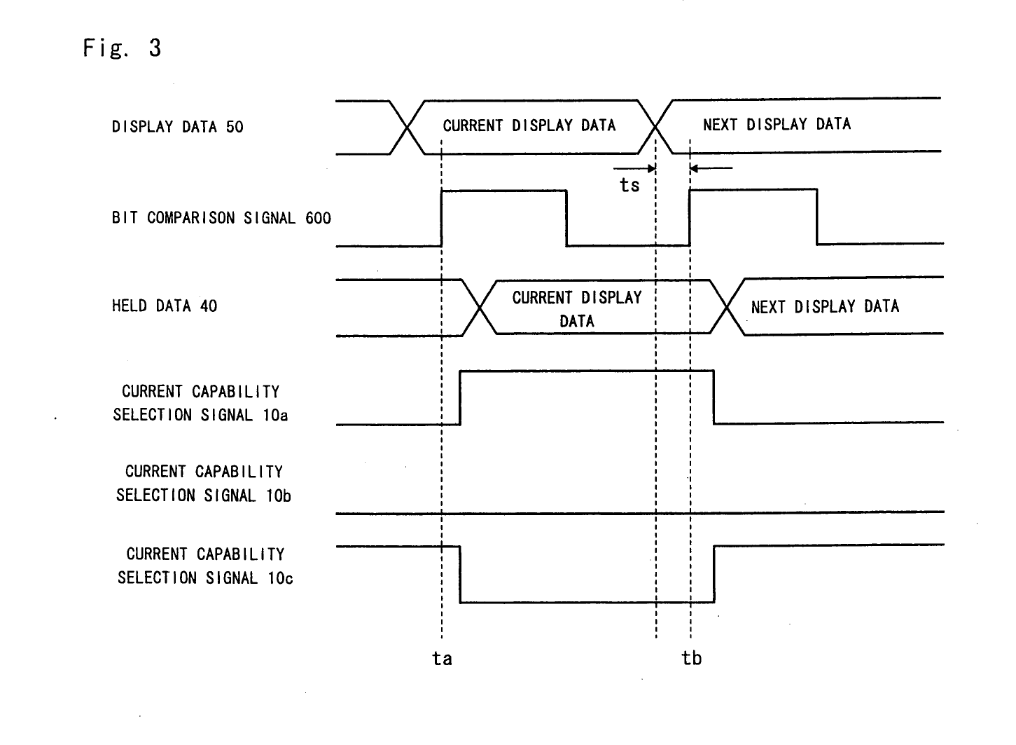

Next, operations of the drive circuit 1 configured as described above will be explained using FIGS. 3 to 5. FIGS. 3 to 5 are timing charts showing the operations in a case where the display data 500 is repeatedly input into the drive circuit 1 according to the embodiment of the present invention. Hereinafter, the operations of the drive circuit 1 will be explained using the following two data as representatives of the repeatedly input display data 500: currently displayed current display data (first display data); and next display data input after the current display data is output and displayed following the current display data (second display data).

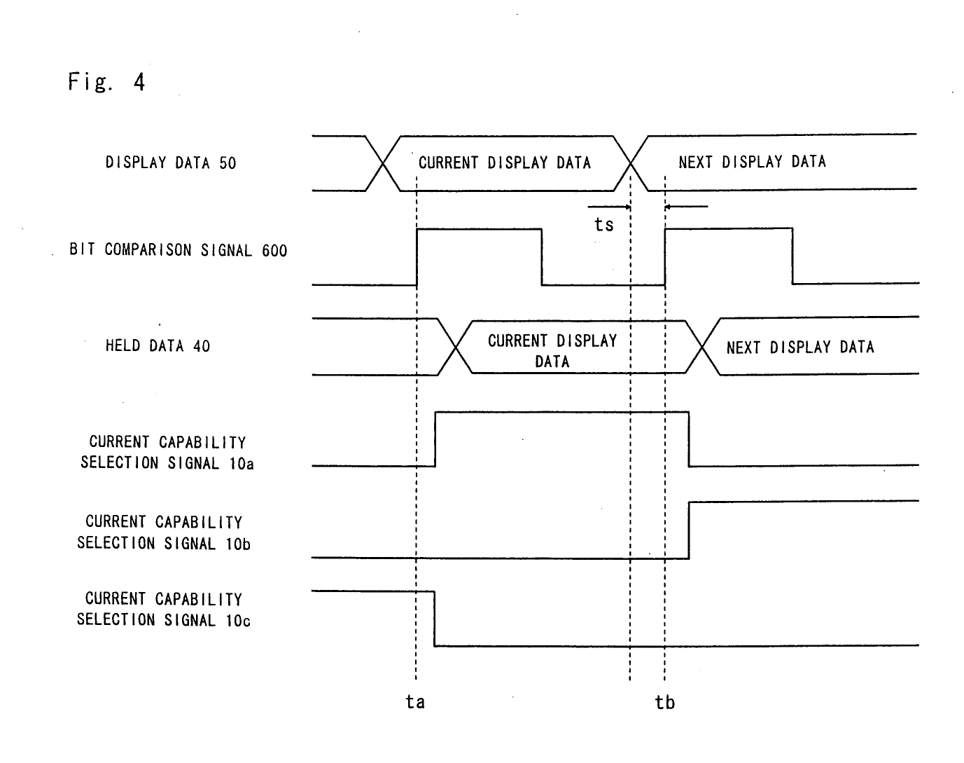

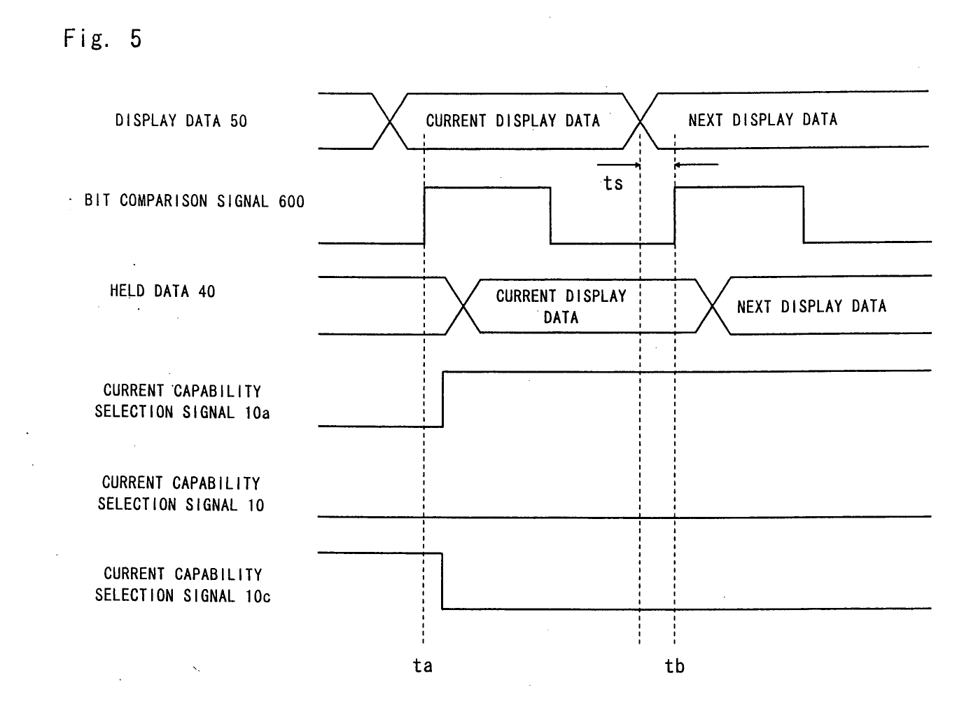

FIG. 3 shows an operation in a case of selecting the constant current source 210c with the lowest current capability as the constant current source 210 that outputs the next display data 500. Similarly, FIG. 4 shows an operation in a case of selecting the constant current source 210b with the middle current capability, and FIG. 5 an operation of the constant current source 210a with the highest current capability, respectively. It is to be noted that as an example, FIGS. 3 to 5 describe the case of having selected the constant current source 210a with the highest current capability as the constant current source 210 that outputs the current display data 500.

As shown in FIGS. 3 to 5, when the current display data 500 is supplied, the current display data 50, which are the most significant two bits of the data 500, are imported into the hold circuit 400 at a timing of a rise time to of the bit comparison signal 600. The hold circuit 400 holds the imported current display data 50, and outputs the held current display data 50 as the held data 40. It is to be noted that the display data 50 are held by the bit as the display data 50a and 50b in the first registers 410 (the MSB1 register 410a and the MSB2 register 410b). Subsequently, the held data 40a and 40b output from each of the first registers 410 are output from the hold circuit 400 as the held data 40.

When next display data 500 is supplied, the next display data 50 that are the most significant two bits of the data 500 and the held data 40 as the current display data 50 held in the hold circuit 400 are input into the data comparison circuit 110. Along with that, the next display data 50 are imported into the hold circuit 400 at a timing of a rise time tb of the bit comparison signal 600. The data comparison circuit 110 compares the next display data 50 with the held data 40 as the current display data 50, and detects a comparison result. Namely, the data comparison circuit 110 outputs any of the comparison result signals 11a, 11b, and 11c as the comparison result.

For example, if both of the most significant two bits of the gradients of the current display data 50 and the next display data 50 are (1, 1) or (0, 0), the comparison result signal 11c is output for selecting the constant current source 210c with the lowest current capability. In addition, if either of the most significant two bits of the gradients of the current display data 50 and the next display data 50 are (1, 1), and if the other one are (0, 0), the comparison result signal 11a is output for selecting the constant current source 210a with the highest current capability. Meanwhile, in cases other than the above-described combination, the comparison result signal 11b is output for selecting the constant current source 210b with the middle current capability.

In other words, if both of the most significant two bits of the gradients are “1”, the display data is determined as white color, if both “0”, black, and in the other cases, half-tone, and then the gradients are compared. If the gradient of the current display data 50 is then white or black color and if that of the next display data 50 is the same white or black color as that, the comparison result signal 11c is output for selecting the constant current source 210c with the lowest current capability. On the contrary to this, if the gradient of the current display data 50 is white or black color and if that of the next display data 50 is black or white color different from that, the comparison result signal 11a is output for selecting the constant current source 210a with the highest current capability. In the other cases, the comparison result signal 11b is output for selecting the constant current source 210b with the middle current capability.

Subsequently, the comparison result signals 11a, 11b, and 11c are imported into the second registers 120 at the next rise time tb of the bit comparison signal 600 to be output as the current capability selection signals 10a, 10b, and 10c, respectively. Namely, the current capability selection signal 10c is output in FIG. 3, the current capability selection signal 10b in FIG. 4, the current capability selection signal 10a in FIG. 5, respectively.

Any of the changeover switches 220a, 220b, and 220c is connected based on the current capability selection signals 10 output from the bit detection circuit 100 as the current capability selection signals 10a, 10b, and 10c. As a result of this, any of the constant current sources 210a, 210b, and 210c is selected. The output circuit 300 then converts the input next display data 500 into a voltage according to a gradient thereof using the selected constant current sources 210a, 210b, or 210c, and then outputs it.

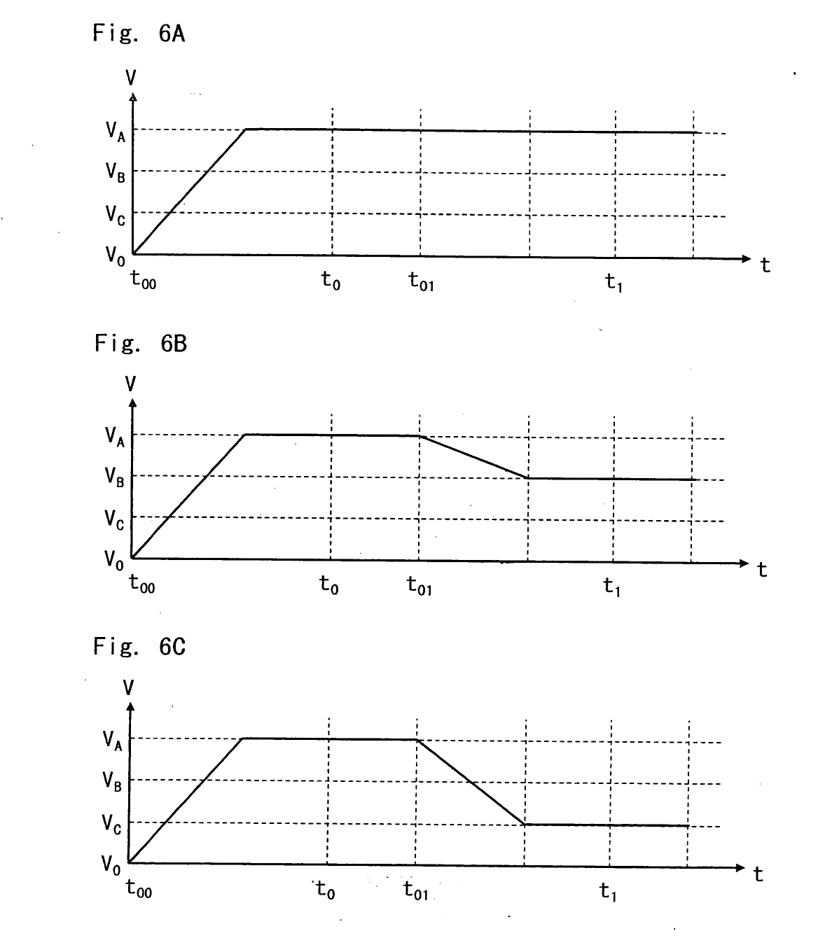

FIGS. 6A to 6C are timing charts showing shifts of output potentials in the liquid crystal display device that mounts the drive circuit 1 of the embodiment of the present invention. FIG. 6A shows a shift of the output potential in a case of outputting the next display data 500 using the constant current source 210c with the lowest current capability. In addition, FIG. 6B shows a shift of the output potential in a case of outputting the next display data 500 using the constant current source 210b with the middle current capability, and FIG. 6C a shift of the output potential in a case of outputting the next display data 500 using the constant current source 210a with the highest current capability, respectively. It is to be noted that here, a case will be explained as an example where the current display data 500 is output as an output potential V_{A}. In FIGS. 6A to 6C, assume that a time at which a gradient of the current display data is output is t₀, and a time at which a gradient of the next display data is output is t₁. Assume that the time t₀ indicates an arbitrary time when an output voltage of the current display data 50 is stable, and that the time t₁ an arbitrary time when an output voltage of the next display data 50 is stable.

If there is no potential change in the shift from the output potential according to the gradient of the current display data 500 to the output potential according to the gradient of the next display data 500, the current capability selection signal 10c is output for selecting the constant current source 210c with the lowest current capability (FIG. 3). For example, if the most significant two bits of the gradient of the current display data 50 are (0, 0), and if those of the next display data 50 are also (0, 0), as shown in FIG. 6A, the shift with no potential change is performed from the output potential V_{A} of the display data with much black color to the output potential V_{A} of the display data with much black color.

At this time, in the current capability selection circuit 200, when the current capability selection signal 10c is input in synchronization with the bit comparison signal 600 of the time tb, connection is changed from the changeover switch 220a to the changeover switch 220c (assume that a time of this time is t₀₁). Namely, a state is changed from a state where the changeover switch 220a has been connected to a state where the changeover switch 220c has been connected by the current capability selection signal 10a shown in FIG. 3. As a result of this, a state is changed from a state where the constant current source 210a has been selected to a state where the constant current source 210c has been selected.

The output circuit 300 converts the input next display data 500 into the voltage V_{A} according to the gradient using the constant current signal 20 from the constant current source 210c. As a result of this, the output potential is, as shown in FIG. 6A, directly shifted from the output potential V_{A} of the current display data 500 of the time t₀ to the output potential V_{A} of the next display data 500 of the time t₁.

Meanwhile, if there is a potential change in the shift from the output potential according to the gradient of the current display data 500 to the output potential according to the gradient of the next display data 500, the current capability selection signal 10b is output for selecting the constant current source 210b with the middle current capability (FIG. 4). For example, if the most significant two bits of the gradient of the current display data 50 are (0, 0), and if those of the next display data 50 are (1, 0), as shown in FIG. 6B, the shift with a potential change is performed from the output potential V_{A} of the display data with much black color to the output potential V_{B} of the display data with half-tone color.

At this time, in the current capability selection circuit 200, when the current capability selection signal 10b is input in synchronization with the bit comparison signal 600 of the time tb, connection is changed from the changeover switch 220a to the changeover switch 220b (assume that a time of this time is t₀₁). Namely, a state is changed from a state where the changeover switch 220a has been connected to a state where the changeover switch 220b has been connected by the current capability selection signal 10a shown in FIG. 4. As a result of this, a state is changed from a state where the constant current source 210a has been selected to a state where the constant current source 210b has been selected.

The output circuit 300 converts the input next display data 500 into the voltage V_{B} according to the gradient using the constant current signal 20 from the constant current source 210b. As a result of this, the output potential is, as shown in FIG. 6B, directly shifted from the output potential V_{A} of the current display data 500 of the time t₀ to the output potential V_{B} of the next display data 500 of the time t₁.

In addition, if there is a largest potential change in the shift from the output potential according to the gradient of the current display data 500 to the output potential according to the gradient of the next display data 500, the current capability selection signal 10a is output for selecting the constant current source 210a with the highest current capability (FIG. 5). For example, if the most significant two bits of the current display data 50 are (0, 0), and if those of the next display data 50 are (1, 1), as shown in FIG. 6C, the shift with a potential change is performed from the output potential V_{A} of the display data with much black color to the output potential V_{C} of the display data with much white color.

At this time, in the current capability selection circuit 200, when the current capability selection signal 10a is input in synchronization with the bit comparison signal 600 of the time tb, the changeover switch 220a continues to be connected (assume that a time of this time is t₀ₜ). Namely, a state is continued where the changeover switch 220a has been connected by the current capability selection signal 10a shown in FIG. 5. As a result of this, the constant current source 210a continues to be selected.

The output circuit 300 converts the input next display data 500 into the voltage V_{C} according to the gradient using the constant current signal 20 from the constant current source 210a. As a result of this, the output potential is, as shown in FIG. 6C, directly shifted from the output potential V_{A} of the current display data 500 of the time t₀ to the output potential V_{C} of the next display data 500 of the time t₁.

As described above, in the embodiment of the present invention, the gradient of the current display data (first display data) is held, the gradient of the next display data (second display data) input following the current display data is compared with the gradient of the held current display data to thereby detect a comparison result, any of the plurality of current capabilities is selected in synchronization with the bit comparison signal based on the comparison result, and the next display data is converted into the voltage according to the gradient of the next display data by the selected current capability and then it is output, thereby controlling the output voltage of the display data supplied to the liquid crystal display panel. As a result of this, the output potential of the current display data can be directly shifted to that of the next display data. Namely, the output potential of the current display data can be shifted to that of the next display data without passing through the output potential V₀. Hence, in the embodiment of the present invention, a wasteful time period tp for shifting to the V₀ once becomes unnecessary when shifting to the output power of the next display data in the drive circuit of the prior art, thus enabling to reduce wasteful consumption current consumed during the time period. Consequently, power consumption can be reduced.

Here, how much consumption current can be reduced will be discussed at the time of the output potential's shifting. For example, assume that consumption current of the constant current source 210b with the middle current capability is set to 0.75 time of a reference value, and consumption current of the constant current source 210c with the lowest current capability is to 0.5 time of the reference value, consumption current of the constant current source 210a with the highest current capability being the reference value.

Combinations of each bit of the display data 50, which are the most significant two bits of the display data 500, are four: (0, 0), (0, 1), (1, 0), and (1, 1). Hence, there are 16 combinations of the changes from the current display data to the next display data, which are obtained by multiplying 4 by 4. Assume that these sixteen kinds of combinations of the display data 500 are input with a uniform probability.

In the embodiment of the present invention, as for combinations using the constant current source 210a with the highest current capability whose consumption current is the reference value 1, there are two kinds of combinations: a combination of the change from the output potential V_{A} of the current display data (0, 0) to the output potential V_{C} of the next display data (1, 1); and a combination of the change from the output potential V_{C} of the current display data (1, 1) to the output potential V_{A} of the next display data (0, 0).

In addition, as for combinations using the constant current source 210c with the lowest current capability whose consumption current is 0.5 times of the reference value, there are two kinds of combinations: a combination of the change from the output potential V_{A} of the current display data (0, 0) to the output potential V_{A} of the next display data (0, 0); and a combination of the change from the output potential V_{C} of the current display data (1, 1) to the output potential V_{C} of the next display data (1, 1).

In addition, as for combinations using the constant current source 210b with the middle current capability whose consumption current is 0.75 times of the reference value, there are combinations other than combinations using the constant current source 210a with the highest current capability and combinations using the constant current source 210c with the lowest current capability. Hence, there are 12 combinations obtained by subtracting 2 twice from 16.

Consequently, if sixteen kinds of combinations of the changes from the current display data to the next display data occur with a uniform probability, consumption current can be calculated by Equation (1) at the time of shifting from the output potential according to the gradient of the current display data to the output potential according to the gradient of the next display data.

2/16×1+2/16×0.5+12/16×0.75=0.75 (1)

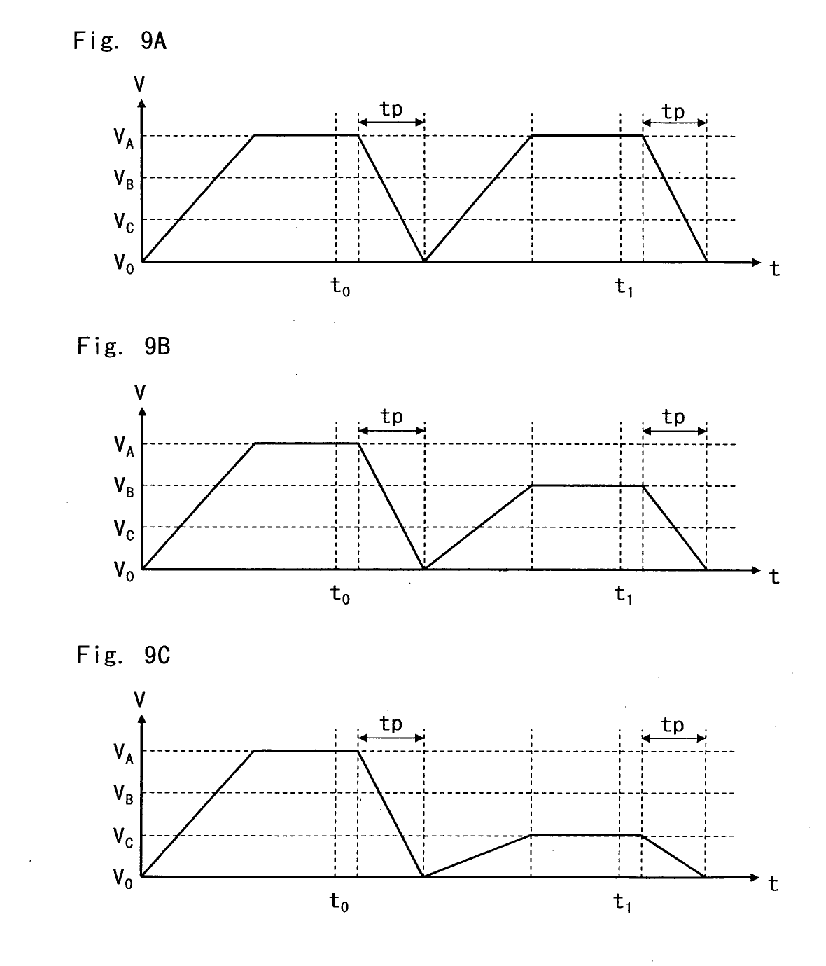

Meanwhile, in the drive circuit of the prior art, as is apparent from the timing charts shown in FIGS. 9A to 9C, consumption current at the time of the output potential's shifting can be expressed by a sum of: the consumption current at the time of shifting from the output potential according to the gradient of the current display data to the V₀; and the consumption current at the time of shifting from the V₀ to the output potential according to the gradient of the next display data. Combinations of shifting from the output potential of the current display data to the V₀ are four, i.e., four cases where the current display data is (0, 0), (0, 1), (1, 0), or (1, 1). Combinations of subsequently shifting from the V₀ to the output potential of the next display data are four, i.e., four cases where the next display data is (0, 0), (0, 1), (1, 0), or (1, 1). Hence, combinations of the shifts from the output potential of the current display data to that of the next display data via the V₀ are 16, which are obtained by multiplying 4 by 4. Assume that these sixteen kinds of combinations of the display data 500 are input with a uniform probability. In the following respective cases, the sum is calculated of the consumption current at the time of shifting from the output potential according to the gradient of the current display data to the V₀, and the consumption current at the time of shifting from the V₀ to the output potential according to the gradient of the next display data.

The shift from the output potential V_{A} of the current display data (0, 0) to the V₀ is performed using the constant current source 210a with the highest current capability whose consumption current is the reference value 1. It is a case of the shift to the output potential V_{A} of the next display data (0, 0) that the constant current source 210a with the highest current capability is subsequently used whose consumption current is the reference value 1 in order to shift from the V₀ to the output potential of the next display data. In addition, it is a case of the shift to the output potential V_{C} of the next data (1, 1) that the constant current source 210c with the lowest current capability is used whose consumption current is 0.5 times of the reference value, and it is a case of the shift of the output potential V_{B} of the next data (0, 1) and (1, 0) that the constant current source 210b with the middle current capability is used whose consumption current is 0.75 times of the reference value. As a result of this, consumption current can be calculated by Equation (2) at the time of shifting from the output potential V_{A} of the current display data (0, 0) to the output potential of the next display data via the V₀.

(1+1)/16+(1+0.75)/16+(1+0.75)/16+(1+0.5)/16=7/16 (2)

In addition, the shift from the output potential V_{C} of the current display data (1, 1) to the V₀ is performed using the constant current source 210c with the lowest current capability whose consumption current is 0.5 times of the reference value. Similarly to the above-described case, combinations of subsequently shifting from the V₀ to the output potential of the next display data are the following ones: the output potential V_{A} of the next display data (0, 0) to which the V₀ is shifted using the constant current source 210a with the highest current capability whose consumption current is the reference value 1; the output potential V_{C} (1, 1) using the constant current source 210c with the lowest current capability whose consumption current is 0.5 times of the reference value; and the output potential V_{B} (0, 1) and (1, 0) using the constant current source 210b with the middle current capability whose consumption current is 0.75 times of the reference value. As a result of this, consumption current can be calculated by Equation (3) at the time of shifting from the output potential V_{C} of the current display data (1, 1) to the output potential of the next display data via the V₀.

(0.5+1)/16+(0.5+0.75)/16+(0.5+0.75)/16+(0.5+0.5)/16=5/16 (3)

Further, the shift from the output potential V_{B} of the current display data (0, 1) to the V₀ is performed using the constant current source 210b with the middle current capability whose consumption current is 0.75 times of the reference value. Similarly to the above-described case, combinations of subsequently shifting from the V₀ to the output potential of the next display data are the following ones: the output potential V_{A} (0, 0) to which the V₀ is shifted using the constant current source 210a with the highest current capability whose consumption current is the reference value 1; the output potential V_{C} (1, 1) using the constant current source 210c with the lowest current capability whose consumption current is 0.5 times of the reference value; and the output potential V_{B} (0, 1) and (1, 0) using the constant current source 210b with the middle current capability whose consumption current is 0.75 times of the reference value. As a result of this, consumption current can be calculated by Equation (4) at the time of shifting from the output potential V_{B} of the current display data (0, 1) to the output potential of the next display data via the V₀.

(0.75+1)/16+(0.75+0.75)/16+(0.75+0.75)/16+(0.75+0.5)/16=6/16 (4)

Still further, the shift from the output potential V_{B} of the current display data (1, 0) to the V₀ is performed using the constant current source 210b with the middle current capability whose consumption current is 0.75 times of the reference value. Similarly to the above-described case, combinations of subsequently shifting from the V₀ to the output potential of the next display data are the following ones: the output potential V_{A} (0, 0) to which the V₀ is shifted using the constant current source 210a with the highest current capability whose consumption current is the reference value 1; the output potential V_{C} (1, 1) using the constant current source 210c with the lowest current capability whose consumption current is 0.5 times of the reference value; and the output potential V_{B} (0, 1) and (1, 0) using the constant current source 210b with the middle current capability whose consumption current is 0.75 times of the reference value. As a result of this, consumption current can be calculated by Equation (5) at the time of shifting from the output potential V_{B} of the current display data (1, 0) to the output potential of the next display data via the V₀.

(0.75+1)/16+(0.75+0.75)/16+(0.75+0.75)/16+(0.75+0.5)/16=6/16 (5)

Consequently, consumption current can be calculated by a sum of Equations (2) to (5), i.e., Equation (6) at the time of shifting from the output potential according to the gradient of the current display data to the output potential according to the gradient of the next display data.

7/16+5/16+6/16+6/16=24/16=1.5 (6)

Hence, according to Equations (1) and (6), in the drive circuit 1 of the embodiment of the present invention, 0.75/1.5×100=50% of the consumption current can be reduced compared with the drive circuit of the prior art.

It is to be noted that the present invention is not limited to the above-described embodiment, and can be arbitrarily modified without departing from the scope of the subject matter thereof. For example, although the case has been explained as an example where the hold circuit 400 has the two first registers 410, the hold circuit 400 may have at least one or more first registers 410. The number of the first registers 410 included in the hold circuit 400 can be arbitrarily decided according to the number of bits used for comparing with the last gradient. In addition, although the case has been explained as an example where the current capability selection circuit 200 has the three constant current sources 210, the number of the constant current sources 210 may be arbitrarily decided. It is to be noted that the number of the second registers 120 included in the bit detection circuit 100 is decided according to the number of the constant current sources 210. Namely, the bit detection circuit 100 has the same number of second registers 120 as the number of the constant current sources 210.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A drive circuit that controls an output voltage of display data supplied to a liquid crystal display panel, the drive circuit comprising:
a hold circuit that holds a gradient of the display data;
a bit detection circuit that compares the gradient of the display data with a last gradient held in the hold circuit to thereby detect a comparison result;
a current capability selection circuit that selects any of a plurality of current capabilities in synchronization with a bit comparison signal based on the detected comparison result; and
an output circuit that converts the display data into a voltage according to the gradient thereof using the selected current capability and outputs the converted voltage.

2. The drive circuit according to claim 1, wherein the hold circuit includes at least one or more first registers for holding the gradient of the display data by the bit.

3. The drive circuit according to claim 1, wherein the bit detection circuit comprises:
a comparison circuit that compares the gradient of the display data with the last gradient held in the hold circuit to thereby detect a comparison result; and
a plurality of second registers for holding the comparison result corresponding to each of the plurality of current capabilities, and
the current capability selection circuit selects any of the plurality of current capabilities based on the comparison result output by the plurality of second registers in synchronization with the bit comparison signal.

4. The drive circuit according to claim 3, wherein
the comparison circuit determines a gradient using at least one or more bits of a plurality of bits that constitute the display data,
the comparison circuit detects the comparison result for selecting the lowest current capability of the plurality of current capabilities if both the gradient of the display data and the last gradient are white or black color, and
the comparison circuit detects the comparison result for selecting the highest current capability of the plurality of current capabilities if either of the gradient of the display data and the last gradient is white color and if the other one is black.

5. The drive circuit according to claim 1, wherein the output circuit converts the display data into the voltage according to the gradient thereof in synchronization with the bit comparison signal and then outputs the converted voltage.

6. A liquid crystal display device wherein the drive circuit according to claim 1 is mounted.

7. A method for controlling an output voltage of display data supplied to a liquid crystal display panel, the method comprising:
holding a gradient of a first display data;
detecting a comparison result by comparing a gradient of a second display data input following the first display data with the gradient of the held first display data;
selecting any of a plurality of current capabilities in synchronization with a bit comparison signal based on the comparison result; and
converting the second display data into a voltage according to the gradient thereof using the selected current capability to output the converted voltage.

8. The method according to claim 7, wherein the second display data is converted into the voltage according to the gradient thereof in synchronization with the bit comparison signal and then the converted voltage is output.
